(19) United States
(12) Patent Application Publication
(10) Pub. No.: US 2025/0154737 A1
(43) Pub. Date: May 15, 2025

(54) VEHICLE LANE SEPARATOR WITH VEHICLE COUNTER DEVICE

(71) Applicant: ZICLACITIES S.L., BARCELONA (ES)

(72) Inventor: Gastón Ezequiel VILLELLA GARCÍA, BARCELONA (ES)

(73) Assignee: ZICLACITIES S.L., BARCELONA (ES)

(21) Appl. No.: 18/940,839

(22) Filed: Nov. 8, 2024

(30) Foreign Application Priority Data
Nov. 9, 2023 (ES) U202331996

(51) Int. Cl. E01F 9/30; E01F 9/553; E01F 9/588; G01S 7/00; G01S 7/03; G01S 13/91

(52) U.S. Cl. CPC E01F 9/30; E01F 9/553; E01F 9/588; G01S 7/003; G01S 7/03; G01S 13/91

(57) ABSTRACT

A vehicle lane separator with vehicle counter device is suitable for separating a bicycle lane from a vehicle lane. The lane separator includes a molded body enabled to be placed on a traffic road, having a general prismatic shape and being internally provided with a plurality of cavities, where a releasably coupled electronic device is incorporated into a non-visible region of the molded body, said device which is enabled to detect the number of vehicles circulating on a bicycle lane, which includes sensor means and a control unit incorporated into a PCB motherboard for detecting the vehicles, wherein a wireless communications module is provided enabled to send data captured by the sensor means to an external server, and autonomous power supply means that supply current to the sensor means and the control unit.

### OBJECT OF THE INVENTION

The object of the invention is to provide a vehicle lane separator, as well as an urban mobility vehicle counting system.

More specifically, the invention proposes the development of a vehicle lane separator, suitable for separating a bicycle lane from a vehicle lane, which is provided with an electronic vehicle counter device that is concealed inside the body of the separator.

### BACKGROUND OF THE INVENTION

The use of road marking devices to indicate the separation between lanes, for example, between lanes for urban mobility vehicles, such as scooters and bicycles, and lanes for motor vehicles and the like is well known in the art prior. Examples of this type are those made up of single-piece bodies provided with a support plane on the ground, which are anchored to the ground in a fixed manner using screws.

Moreover, the increase in urban mobility vehicle users in recent years is well known, such that a greater number of lanes for said vehicles is required. This increase is creating new challenges in the design of new urban networks of lanes and infrastructures intended for them; however, their design is not always adequate due to the lack of measurement studies of the vehicles that circulate on these types of lanes. Therefore, there is a need today for systems that can measure the volume of vehicles of this type without the need to install systems or devices on public roads, which do not require a connection to the electrical grid or a space to be occupied on the public road.

Furthermore, the applicant is not currently aware of any invention that has all of the features described in this specification.

### DESCRIPTION OF THE INVENTION

The present invention has been developed with the aim of providing a lane separator device that is configured as a novelty within the field of application and solves the previously mentioned drawbacks, further contributing other additional advantages that will be obvious from the description below.

Therefore, an object of the present invention is to provide a vehicle lane separator, suitable for separating a lane for vehicles such as bicycles from a motor vehicle lane, said separator comprising a moulded body that is enabled to be placed on a traffic road, having a general prismatic shape and being internally provided with a plurality of cavities. In particular, the invention is characterised in that a releasably coupled electronic device is incorporated into a non-visible region of the moulded body, said device which is enabled to detect the number of vehicles circulating on a bicycle lane, which includes sensor means and a control unit incorporated into a PCB motherboard, for detecting the vehicles, which has a wireless communications module enabled to send data captured by the sensor means to an external server, and autonomous power supply means that supply current to the sensor means and the control unit.

Preferably, the sensor means comprise a device based on coherent pulse radar technology, so that it is not required to be partially exposed to the outside since it is not based on light or sound. This radar technology is based on the generation of pulses in a continuous manner over time, so that it detects the noise generated around the radar location and has the ability to segregate the noise generated by elements other than the vehicles to be counted.

According to the invention, the autonomous power supply means consist of at least one rechargeable battery connected to the PCB motherboard by wiring.

Advantageously, the electronic device includes a GPS location module configured to provide location information, making it possible to track and analyse the location in the installation of a network of separators provided with the electronic counter device.

According to the invention, the electronic device may be made up of a first removable casing which houses the sensor means and the control unit incorporated into the PCB motherboard, and a second removable casing which houses the power supply means, where each of the casings has a geometry and outer dimensions that correspond to the dimensions of the cavities provided in the moulded body, and are connected to each other by wiring. Thus, no hardware elements are required, which simplifies the mounting of the electronic device inside the separator.

Preferably, the moulded body is made of rubber material or the like.

Due to these features, a device with a dual function is obtained: on the one hand, it acts as a lane separator and, on the other hand, it allows information to be collected from and sent, in a way that is not externally visible, to users who circulate on a lane for urban mobility vehicles, so that it is protected from inclement weather, knocks or dirt, providing robustness and durability.

It is worth mentioning that the fact that the electronic device can be removed allows it to be disassembled and placed in any separator, thus avoiding the manufacture of separators with a new design that increases manufacturing costs.

In addition, having rechargeable power supply means provides autonomy to the electronic device, so that the batteries only need to be recharged when necessary.

Another object of the invention is to provide an urban mobility vehicle counting system, intended to count the vehicles circulating on an urban mobility vehicle lane (such as, for example, bicycles, electric scooters) at a given point, and characterised in that it comprises at least one lane separator as described above, and an external server that is in data communication with the lane separator through the control unit, wherein the external server incorporates a software for real-time management of the data received from the control unit.

Thus, the lane separator described represents an innovative structure with structural and constituent features heretofore unknown for its intended purpose, reasons which, taken together with its usefulness, provide it with sufficient grounds for obtaining the requested exclusivity privilege.

Other features and advantages of the lane separator object of the present invention will be evident in light of the description of a preferred, but not exclusive, embodiment which is illustrated by way of a non-limiting example in the drawings which are attached, wherein:

### BRIEF DESCRIPTION OF THE DRAWINGS

FIG. 1 is a schematic perspective view of a lane separator according to the present invention;

FIG. 2 is a bottom perspective view of the lane separator of FIG. 1;

FIG. 3 is a schematic view of the main components that form part of the electronic urban mobility vehicle counter device;

FIG. 4 is a schematic view of a system provided with multiple separators of the invention; and

FIG. 5 is an isometric view of the arrangement of the lane separator according to the invention.

### DESCRIPTION OF A PREFERRED EMBODIMENT

In view of the aforementioned figures, and in accordance with the adopted numbering, a preferred exemplary embodiment of the invention is disclosed, which comprises the parts and elements indicated and described in detail below.

Moreover, the terms first, second, third, and the like in the description and in the claims are used to distinguish between similar elements and not necessarily to describe a sequential or chronological order. The terms may be interchanged under appropriate circumstances and the embodiments of the invention may operate in sequences other than those described or illustrated herein.

Moreover, the terms upper, lower, up, down, and the like in the description and in the claims are used for descriptive purposes and not necessarily to describe relative positions.

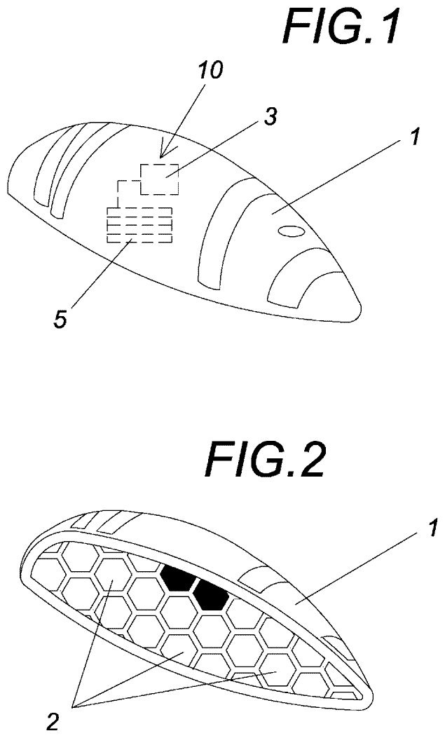

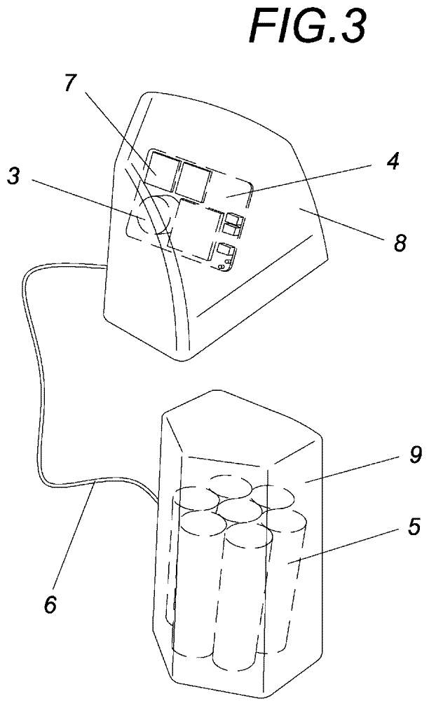

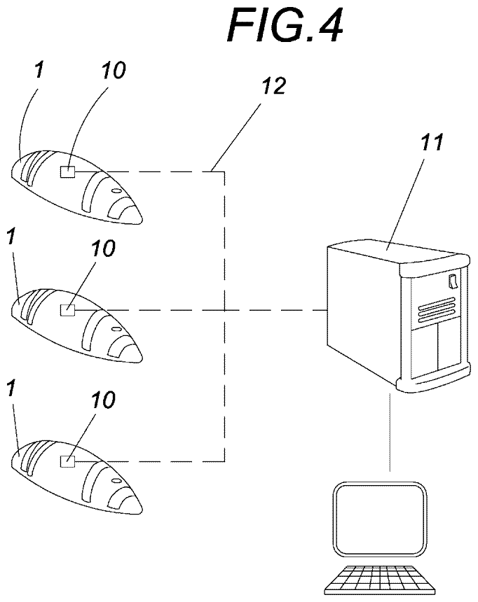

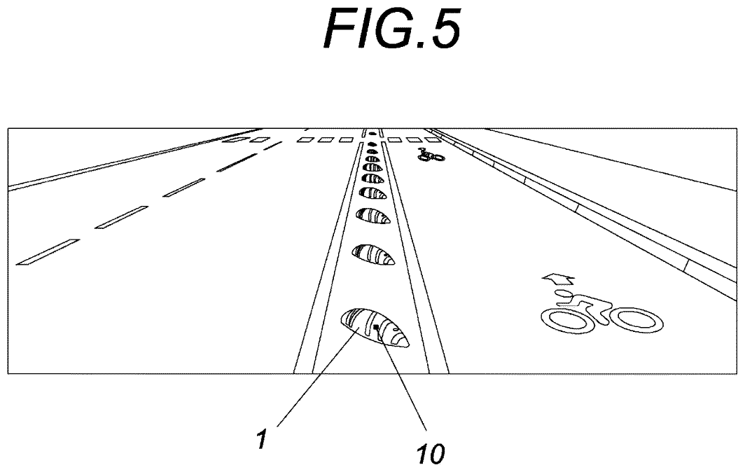

As can be seen in FIGS. 1 and 2, a vehicle lane separator, suitable for separating a bicycle lane from a motor vehicle lane (such as cars), comprises a moulded body (1) made of rubber, PVC or other suitable material, which is enabled to be placed on a traffic road, having a general prismatic shape and being internally provided with a plurality of cavities (2) formed from a rib structure.

A releasably coupled electronic device, generally indicated with reference (10), is incorporated inside of cavities and therefore in a non-visible region of the moulded body, said device which is enabled to detect the number of vehicles circulating on a bicycle lane, which includes sensor means (3) and a control unit incorporated into a PCB motherboard (4) for detecting and counting the vehicles, which has a wireless communications module enabled to send data captured by the sensor means (3) to an external server, and autonomous power supply means (5) that supply current to the sensor means (3) and the control unit. It is worth mentioning that the control unit has a software that allows for low power consumption.

Regarding the sensor means (3), they comprise a device based on coherent pulse radar technology.

The aforementioned autonomous power supply means (5) consist of a plurality of rechargeable batteries that are characterised by very low consumption, which provides long operating autonomy, and which are connected to the control unit through a cable (6).

Advantageously, the electronic device includes a GPS location module (7) that is configured to provide location information of the separator, thereby allowing a network of separators provided with the electronic counter device (10) to be managed more efficiently.

Now returning to the electronic device (10), it is made up of a first removable casing (8) which houses the sensor means and the control unit, and a second removable casing (9) which houses the power supply means, where each of the casings (8, 9) has a geometry and outer dimensions that correspond to the dimensions of the cavities (2) wherein the same are housed.

Due to the invention, it is possible to obtain an urban mobility vehicle counting system, intended to count the vehicles circulating on a bicycle lane at a given point, comprising a plurality of lane separators as described above, and an external server (11) that is in data communication with the lane separator through the wireless communications module (12) of the control unit. The external server (11) incorporates a software for real-time management 5 of the data received from the control unit.

The details, shapes, dimensions and other accessory elements, used to manufacture the lane separator of the invention, may be suitably substituted for others which do not depart 10 from the scope defined by the claims which are included below.

1-7. (canceled)

8. A vehicle lane separator with a vehicle counter device, suitable for separating a bicycle lane from a vehicle lane, the vehicle lane separator comprising:
a molded body that is enabled to be placed on a traffic road, having a general prismatic shape and being internally provided with a plurality of cavities,
wherein a releasably coupled electronic device is incorporated into a non-visible region of the molded body, the device which is enabled to detect the number of vehicles circulating on a bicycle lane, which includes sensor means and a control unit incorporated into a PCB motherboard for detecting the vehicles,
wherein a wireless communications module is provided enabled to send data captured by the sensor means to an external server, and autonomous power supply means that supply current to the sensor means and the control unit.

9. The vehicle lane separator according to claim 8, wherein the sensor means comprise a device based on coherent pulse radar technology.

10. The vehicle lane separator according to claim 8, wherein the autonomous power supply means consist of at least one rechargeable battery connected to the PCB motherboard by wiring.

11. The vehicle lane separator according to claim 8, wherein the electronic device includes a GPS location module configured to provide location information.

12. The vehicle lane separator according to claim 8, wherein the electronic device is made up of a first removable casing which houses the sensor means and the control unit incorporated into the PCB motherboard, and a second removable casing which houses the power supply means, where each of the first and second casings has a geometry and outer dimensions that correspond to the dimensions of the cavities of the molded body, and are connected to each other by wiring.

13. The vehicle lane separator according to claim 8, wherein the molded body is made of rubber material or the like.

14. An urban mobility vehicle counting system for counting vehicles circulating on an urban mobility vehicle lane at a given point, the urban mobility vehicle counting system comprising:
at least one vehicle lane separator,
the vehicle lane separator with a vehicle counter device, suitable for separating a bicycle lane from a vehicle lane, the vehicle lane separator comprising:
a molded body that is enabled to be placed on a traffic road, having a general prismatic shape and being internally provided with a plurality of cavities,
wherein a releasably coupled electronic device is incorporated into a non-visible region of the molded body, the device which is enabled to detect the number of vehicles circulating on a bicycle lane, which includes sensor means and a control unit incorporated into a PCB motherboard for detecting the vehicles,
wherein a wireless communications module is provided enabled to send data captured by the sensor means to an external server, and autonomous power supply means that supply current to the sensor means and the control unit; and
an external server that is in data communication with the vehicle lane separator through the wireless communications module of the control unit,
wherein the external server incorporates a software for real-time management of the data received from the control unit.
